(19) United States
(12) Patent Application Publication
(10) Pub. No.: US 2004/0100918 A1
(43) Pub. Date: May 27, 2004

(54) Method and system for forwarding a control information

(76) Inventors: Antti Toskala, Espoo (FI); Esa Malkamaki, Espoo (FI)

Correspondence Address: ANTONELLI, TERRY, STOUT & KRAUS, LLP, 1300 NORTH SEVENTEENTH STREET, SUITE 1800, ARLINGTON, VA, 22209-9889, US

(21) Appl. No.: 10/304,949

(22) Filed: Nov. 27, 2002

(51) Int. Cl. H04Q 7/00

(52) U.S. Cl. 370/314; 370/337

(57) ABSTRACT

The present invention relates to a method and system for forwarding a control information in a transmission signal of a communication network. A dummy information is provided in at least one predetermined portion of the transmission signal, and is replaced at least partly by the control information at a control device arranged on the transmission path of the transmission signal. Signaling space is thus generated by creating the dummy information. Thereby, a fast control signaling can be provided which does not have to be originated at a network controlling functionality. Furthermore, if a dedicated link is used, less power is required and designing of new physical channel types is not required.

### FIELD OF THE INVENTION

The present invention relates to a method and system for forwarding to a controlled unit a control information in a transmission signal of a communication network, e.g. a third generation cellular network.

### BACKGROUND OF THE INVENTION

Within the International Telecommunications Union (ITU), several different air interfaces are defined for third generation mobile communication systems, based on either Code Division Multiple Access (CDMA) or Time Division Multiple Access (TDMA) technology. Wideband CDMA (WCDMA) is the main third generation air interface and will be deployed in Europe and Asia, including Japan and Korea, in the same frequency band, around 2 GHz.

WCDMA technology has shaped the WCDMA radio access network architecture due to the requirements of CDMA basic features, such as soft handover which is a category of handover procedures where the radio links are added and abandoned in such a manner that the terminal device, or user equipment (UE) in third generation terms, keeps at least one radio link to the radio access network.

The WCDMA air interface is based on CDMA technology. All users share the same carrier, and also share this carrier's power. The characteristic feature is the wide 5 MHz carrier bandwidth over which the signal for each user is spread. The transmission bandwidth is the same for all data rates, with the processing gain being larger for smaller data rates than for higher data rates. This processing gain protects against interference from other users active on the same carrier. In the receiver, dispreading separates the transmitted and spread signal for data detection.

CDMA technology enables two key features, fast power control and soft handover. They both contribute to WCDMA system capacity but are also required for proper system operation. A fast power control, especially in the uplink, is required so that consumers do not generate extra interference and do not block the reception of the signals from other consumers. Without power control, a mobile device transmitting near a base station would block the reception of the other consumers further away if it exceeds the processing gain. The soft handover feature is required for similar reasons. In a soft handover, a mobile device is connected simultaneously to two or more cells on the same frequency. Especially in the uplink, this is again vital since otherwise a mobile device between two cells could cause problems to the cell to which it is not connected. In a soft handover, all cells provide power control information to the mobile device.

The WCDMA air interface has been defined to provide, in the first phase, data rates up to 2 Mbps in the 3GPP (third generation partnership project) Release 99 and Release 4 specifications. In the Release 5 specification, peak data rates up to 10 Mbps are possible with a high speed downlink packet access (HSDPA) feature to thereby support packet-based multimedia services. In HSDPA, the intelligence of the Node B, which is the third generation equivalent to the former base station, is increased for handling of retransmissions and scheduling functions, thus reducing the roundtrip delay between a mobile device and the network entity handling retransmissions, e.g. the radio network controller (RNC). This makes retransmission combining feasible in the mobile device due to reduced memory requirements. In general, all HSDPA users share the channel in both time and code domains. Adaptive modulation and coding is used to support multiple rate transmissions for different types of multimedia services.

In order to standardize the complementary uplink structure, i.e. Enhanced Uplink Packet Access (EUPA), to the HSDPA feature, it is expected to require the transmission of control information from the Node B, i.e. base station device, directly to the UE, i.e. terminal device, without involving the RNC or using a RRC (Radio Resource Control) signaling.

Document WO 02/03600 A1 discloses a signaling method, wherein the space for feedback signaling is proposed to be generated in the same way as in a compressed mode, i.e. either by puncturing or by higher layer signaling. Thus, the data will be punctured a bit more in rate matching so that given slots or parts of the slots can be left empty and filled with feedback information.

### SUMMARY OF THE INVENTION

It is an object of the present invention to provide a network feature or functionality, by means of which a control information can be forwarded in a transmission signal of a communication network without having to route the information via a network controlling device and which may also be used in soft handover cases involving devices that do not support this functionality.

This object is achieved by a method of forwarding a control information to a controlled unit in a transmission signal, said method comprising the steps of:

providing dummy information in at least one predetermined portion of said transmission signal;

replacing at least part of said dummy information by said control information at a control device arranged on the transmission path of said transmission signal; and

transmitting said transmission signal with said added control information to said controlled unit.

Furthermore, the above object is achieved by a system for forwarding to a controlled unit a control information in a transmission signal, said system comprising:

signal generating means for providing said transmission signal with dummy information in at least one predetermined portion of said transmission signal; and

a control unit arranged on the transmission path of said transmission signal and adapted to replace at least part of said dummy information by said control information and to transmit said transmission signal with said added control information to said controlled unit.

Additionally the above object is achieved by a control device of a cellular network, said control device comprising:

receiving means for receiving a transmission signal;

replacing means for replacing at least part of a dummy information provided in at least one predetermined portion of said transmission signal by a control information; and

transmitting means for transmitting said transmission signal with said added control information to a controlled device to be controlled based on said control information.

Finally, the above object is achieved by a device to be controlled by a control information, said controlled device comprising:

deriving means for deriving from a transmission signal received at said controlled device a location information of a channel used for transmitting said control information; and

extracting means for extracting said control information based on said derived location information.

Accordingly, a much faster control signaling can be provided as compared to a network controller originated signaling. The control information can be added directly at an intermediate network node, e.g. a base station device or Node B, such that the data rate provided over the other transmission channels or the control signaling load of the network is not influenced. Due to the fact that a dedicated link can be used, less power is required and no new physical channel types have to be designed, as compared to the use of shared control channels. Moreover, from the controlled unit's point of view, no new channels have to be decoded so that circuit complexity will not be increased.

Furthermore, devices which do not support this new network functionality simply ignore this feature and just send the dummy information which will again be ignored at the controlled unit.

The transmission signal may be a dedicated time multiplex signal. Then, the dummy information may be provided at a fixed position or a flexible position within a time slot of the time multiplex signal. The fixed position may correspond to at least the last symbol of the time slot. Alternatively, the fixed position may correspond to a dummy transport channel configured to use fixed position. Furthermore, fixed position of dummy bits are possible even when transport channels use flexible positions. Then, the position of at least the first transport channel is always known as well as the position of DTX (Discontinuous Transmission) indication bits which may be used as the dummy information. If the dummy transport channel is provided at fixed positions, any transport channel can be used the dummy transport channel. On the other hand, if the dummy transport channel is provided at flexible positions, the first and/or last transport channel can be used the dummy transport channel. In case of the flexible position, one specific transport channel (configured to be in flexible position) can be selected for transmitting the dummy information. In this case, the flexible positions can be determined at the controlled unit based on a format indication information, such as the TFCI (Transport Format Combination Indicator) of the time slot.

Thus, in case of the fixed positions, portions which are most likely to be unused can be used as dummy data positions for forwarding the specific control signaling. Due to the fixed positions, the bits are always in known positions even if a later interleaving function will distribute the bits. The use of flexible positions generally requires decoding of the transmission format indication information. However, if the dummy information is inserted to the transport channel number one (which, if present, is always input first to transport channel multiplexer), then the position of this transport channel is always known. Furthermore, when the number of bits is known, then the positions of the bits are known.

The dummy information may be transmitted periodically, e.g. in every frame of amultiplex signal having a frame and slot structure.

Non-replaced dummy information may be replaced at said control device by a discontinuous transmission information (DTX).

Also, the DTX indication bits can be considered as dummy bits. These are not explicitly added at higher protocol layers, but the way to provide these dummy bits, i.e. DTX indication bits in this case, is to define the transport format combinations (TFC) such that there is always room for DTX. When flexible positions of transport channels (TrCH) are used, then all the DTX indication bits are at the end of the frame after TrCH multiplexing. After interleaving they will be distributed more or less evenly into all slots and the positions of these DTX indication bits are known to be at the end of the first and second half of the data field of each slot. The data field of a slot here is understood as the combined data field consisting of data1 and data2 fields, i.e., data field=data1+data2 and the length of each half is then (Ndata1+Ndata2)/2. For instance, if TFCs are configured such that there is always at least 30 DTX indication bits per frame, then after interleaving there are at least two DTX indication bits per slot and these DTX indication bits are the last bits of the first and second half of the data field, i.e., bits number (Ndata1+Ndata2)/2−1 and (Ndata1+Ndata2)−1, assuming that the data bits within a slots are numbered from 0 to Ndata1+Ndata2−1. In the downlink, the Node Bs willing to send control information to the UE would replace the DTX indication bits by the control information in the given slots. All unused DTX indication bits (e.g., in other slots) would not be transmitted. The Node Bs not sending this control information (either because they are of older version not capable of sending this control information or because they at the moment have no control information to be sent) will simply not send those bits as in the normal specified operation with DTX indication bits.

The advantage of using the DTX indication bits as dummy bits is that their position within the slots is always known (provided that the number of DTX indication bits is known) both when fixed or flexible TrCH positions are used, or at least the positions of the last N DTX indication bits per frame are known provided that there are at least N DTX indication bits in each TFC configured to be used with the proposed control function.

If the control information is not very time critical, it can be spread over the whole frame, i.e., the control signaling may be interleaved over a whole frame of the time multiplex signal. Then, the replacing step may be performed at the control device before channel coding and multiplexing.

Alternatively, the control signaling may be transmitted in selected time slots of the time multiplex signal due to tight delay or processing time requirements. In this case, the replacing step may be performed after a final interleaving operation, when the final positions of the dummy bits in the selected time slots are known. Thus, the control device knows the positions and can insert the signaling bits to the selected slots after the final interleaving. If the control bits replacing the dummy bits are in flexible positions, then the receiver at the control unit has to wait until the end of the radio frame to decode the transport format indication information before it knows the positions. This can be beneficial compared with the case where the signaling is interleaved over the whole TTI, in that it gives more processing time for the control device for signaling in the other transmission direction. If the last slots of the frame are used, the available additional processing time of the control device is maximized. The control signaling need not be ready when the transmission of the frame starts if it is added only to the last slots of the frame, just before they are transmitted. The dummy bits in the earlier slots can be used for some other, possibly less time critical control information or the dummy bit positions can be left unused.

The transmission signal may be an uplink or downlink signal of the cellular network. As an example, the control information may comprise a HSDPA signaling information or signaling information for enhanced uplink.

The extracting means of the terminal device may be adapted to receive an indication information from the cellular network, indicating the presence of the control information. As an example, the indication information may be supplied from the cellular network by an RRC (Radio Resource Control) or broadcast signaling.

### BRIEF DESCRIPTION OF THE DRAWINGS

In the following, the present invention will be described in greater detail based on preferred embodiments with reference to the accompanying drawings, in which:

FIG. 1 shows a schematic diagram of a network architecture in which the present invention can be implemented;

FIG. 2 shows a schematic diagram of a frame structure after TrCH multiplex with fixed positions of TrCHs, as well as the corresponding slot structure;

FIG. 3 shows a schematic diagram of a frame structure after TrCH multiplex with flexible positions of TrCHs, as well as the corresponding slot structure;

FIG. 4 shows a schematic diagram of a frame and slot structure according to a first preferred embodiment with DTX indication bits replaced with control information;

FIG. 5 shows a schematic diagram of a frame and slot structure according to a second preferred embodiment with dummy information in fixed position using the first transport channel as a dummy transport channel;

FIG. 6 shows a schematic diagram of a frame and slot structure according to a third preferred embodiment with dummy information in fixed positions using a dummy transport channel in a fixed position;

FIG. 7 shows a schematic diagram of a frame and slot structure according to a fourth preferred embodiment with dummy information in flexible positions using a dummy transport channel in a flexible position.

FIG. 8 shows a schematic block diagram of a transport channel multiplexing structure for a downlink direction according to the first to fourth preferred embodiments;

FIG. 9 shows a schematic block diagram of a channel demultiplexing structure in the downlink direction according to the first to fourth preferred embodiments; and

FIG. 10 shows a general schematic block diagram of the forwarding system according to the present invention.

### DESCRIPTION OF THE PREFERRED EMBODIMENTS

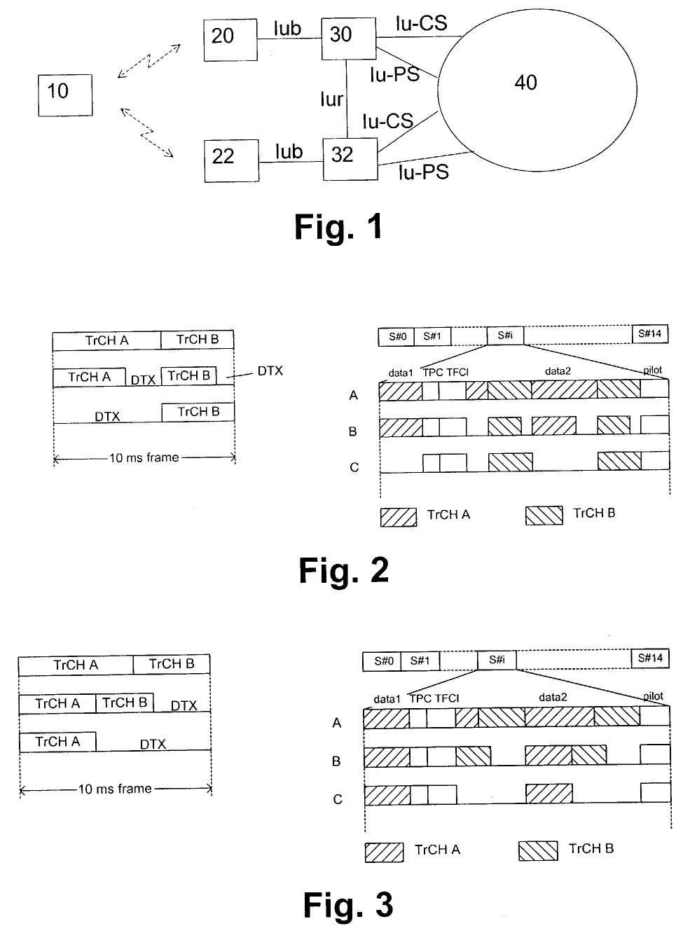

The preferred embodiments will now be described on the basis of a third generation WCDMA radio access network architecture as shown in FIG. 1.

FIG. 1 shows a terminal device or UE 10 connected via an air interface to a first Node B 20 and/or a second Node B 22. The first and second Node Bs 20, 22 are connected via respective lub interfaces to first and second radio network controllers (RNCs) 30, 32 which are connected to each other via a lur interface. The Node Bs 20, 22 are logical nodes responsible for radio transmission and reception in one or more cells to/from the UE 10 and terminate the lub interface towards the respective RNCs 30, 32. The RNCs 30, 32 are in charge of controlling use and integrity of radio resources within the radio access network. Furthermore, the RNCs 30, 32 provide connections to a third generation core network 40, e.g. a UMTS (Universal Mobile Telecommunications System) network for both circuit-switched traffic via a lu-CS interface and packet-switched traffic via a lu-PS interface. The existence of an open standardized lur interface is essential for proper network operation, including soft handover support in a multi-vendor environment.

According to the preferred embodiments, a network functionality is provided by means of which a control information, e.g. a HSDPA or other signaling information, can be exchanged between the Node Bs 20, 22 and the UE 10 without involving the respective RNCs 30, 32. To achieve this, a dummy information or dummy bits are provided at predetermined positions of a dedicated uplink or downlink signal. These positions can then be used by the Node Bs 20, 22 or by the UE 10 to insert a desired control signaling, i.e. replace the dummy information or dummy bits by the desired control information or control bits. Thus, the dummy information or dummy bits can be regarded as fictive information or data, which does not carry any specific information.

FIG. 2 shows schematic diagrams of a frame structure after TrCH multiplexing with fixed positions of TrCHs as well as the corresponding slot structure. In the WCDMA system, each frame consists of 15 slots S#0 to S#14, of which each slot comprises two Transport Format Combination Indicator (TFCI) bits which together with TFCI bits from other slots of the frame represent the current transport format combination, i.e. the combination of currently valid transport formats on all transport channels of the concerned UE. In particular, the transport format combination contains one transport format for each transport channel. Furthermore, each time slot of the frame structure of the time multiplex transmission signal between the UE 10 and the Node Bs 20, 22 comprises a first data field data1 and a second data field data2 separated by a transmit power control command TPC field used for the initially described power control function as well as the TFCI bits described above. Finally, each slot comprises known pilot bits to support channel estimation for coherent detection. The transport channels TrCH A and TrCH B are channels offered by the physical layer to Layer 2 for data transport between peer Layer 1 entities. Different types of transport channels are defined by how and with which characteristic data is transferred on the physical layer, e.g. further using dedicated or common physical channels. Further details concerning the WCDMA frame structure are described in the 3GPP specifications TS 25.211 and 25.212.

In FIG. 2, in case A, TrCH A and TrCH B fill the frame (and thus also the slots) fully. In the case B, both transport channels have less bits and thus DTX is introduced at the end of both transport channels. Finally, in case C only TrCH B is present and TrCH A bits are all replaced with DTX (no transmission). The left-hand and right-hand diagrams show for each of the cases A, B and C how the transport channels as well as the DTX are positioned within the frame and each slot when fixed positions are used for the transport channels.

FIG. 3 shows schematic diagrams of a frame structure after TrCH multiplexing with flexible positions of TrCHs as well as the corresponding slot structure. In case A, TrCH A and TrCH B fill the frame (and thus also the slots) fully. In the case B, both transport channels have less bits and thus DTX is introduced but now it is added at the end of the frame. Finally, in case C only TrCH A is present and TrCH B bits are all replaced with DTX (no transmission). The diagrams show how the transport channels as well as the DTX are positioned within the frame and each slot when flexible positions are used for the transport channels.

In the following, preferred embodiments are described, in which the dummy information is provided in a predetermined position of a time slot of a time multiplex signal. The dummy information is provided either at fixed positions or at flexible positions within the frame structure of the time multiplex signal. There are several possibilities how the fixed positions for the dummy bits can be arranged.

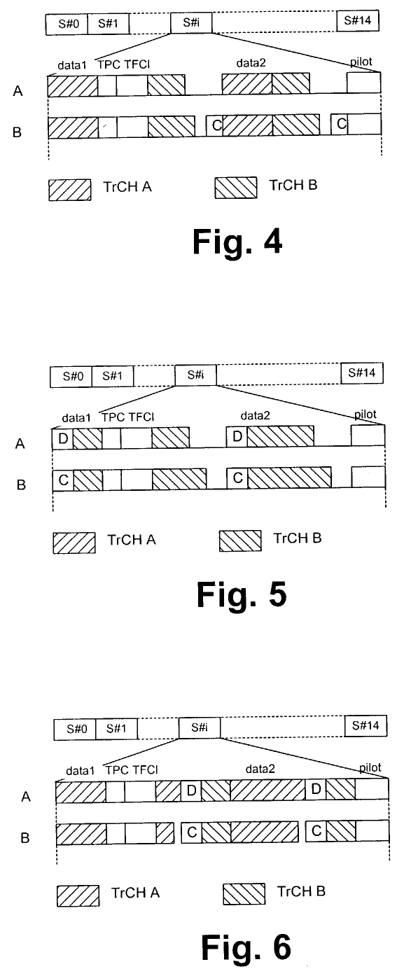

FIG. 4 shows a frame structure for a control information transmission scheme according to the first preferred embodiment. In the first preferred embodiment, the DTX indication bits are used as dummy bits and thus the control information C replaces at least some of the DTX indication bits. The replaced DTX bits are preferably some of the last bits in the frame which after interleaving appear at the end and in the middle of the slot. FIG. 4 shows the frame structure for flexible position of TrCHs, in which case the DTX bits are always placed at the end of the frame (as shown also in FIG. 3).

In FIG. 4, the upper slot structure A corresponds to a conventional slot structure with DTX bits. The lower slot structure B indicates a slot structure where some of the DTXed ‘bits’ have been replaced by control bits C to be forwarded via the air interface of the radio access network.

In the first preferred embodiment, the Node Bs 20, 22 using, e.g., advanced uplink scheduling improvements, as informed to the UE 10, are arranged to use the DTX indication bits provided in each slot, for the Node B specific control signaling, e.g. a HSDPA control signaling or the like. Other Node Bs not involved in the improved uplink scheduling operation do not transmit anything there, i.e. do not replace the DTX indication bits by the control bits C.

It is noted that the dummy bits D may not only be provided at a certain portion of the concerned transmission channel, but a whole dummy transmission channel (dummy TrCH) may be provided within the slot structure, which is the case in FIG. 5 and FIG. 6.

FIG. 5 shows a frame structure for a control information transmission scheme according to the second preferred embodiment. In the second preferred embodiment, transport channels with flexible positions are used. Then preferably the first transport channel is configured as the dummy transport channel, since it is always in the known position within the frame as well as within the slots. In FIG. 5, TrCH A has been configured as dummy transport channel and the dummy data D on the upper slot structure A is replaced with the control data C on the lower slot structure B. It is noted that the position of the dummy transport channel is not changed even if the amount of data for TrCH B is changed between slot structures A and B.

FIG. 6 shows a frame structure for a control information transmission scheme according to the third preferred embodiment. In the third preferred embodiment, transport channels with fixed positions are used. Then any transport channel may be configured as the dummy transport channel, since all the transport channels are always in the known position within the frame as well as within the slots. In FIG. 6, a third transport channel between TrCH A and B has been configured as dummy transport channel and the dummy data D on the upper slot structure A is replaced with the control data C on the lower slot structure B. Notice that due to the fixed positions of the transport channels, the position of the dummy transport channel is not changed even if the amount of data for TrCH A or B is changed between slot structure A and B.

The control bits C to be inserted at the dummy bits D can be interleaved over the whole frame, e.g. 10 ms or can be transmitted within some selected slots due to timing requirements.

If the control signaling bits are interleaved over the whole frame, the dummy transmission channel or channel portion can be seen as a normal transmission channel terminated in the Node B. The signaling bits can be inserted before channel coding and multiplexing. They may then pass the transmission functions of CRC (cyclic redundancy code) attachment, channel coding, rate matching, interleaving etc. At the receiving function of the UE 10, the whole frame F has to be received before this signaling can be decoded.

If the signaling bits are transmitted in selected time slots, the dummy bits D are replaced by the control bits C at the selected slots after the final interleaving function, i.e. the second interleaving in the present WCDMA system, when the final positions are known. Non-used or non-replaced dummy bits D may preferably be replaced by DTX indication bits, i.e., they are not transmitted.

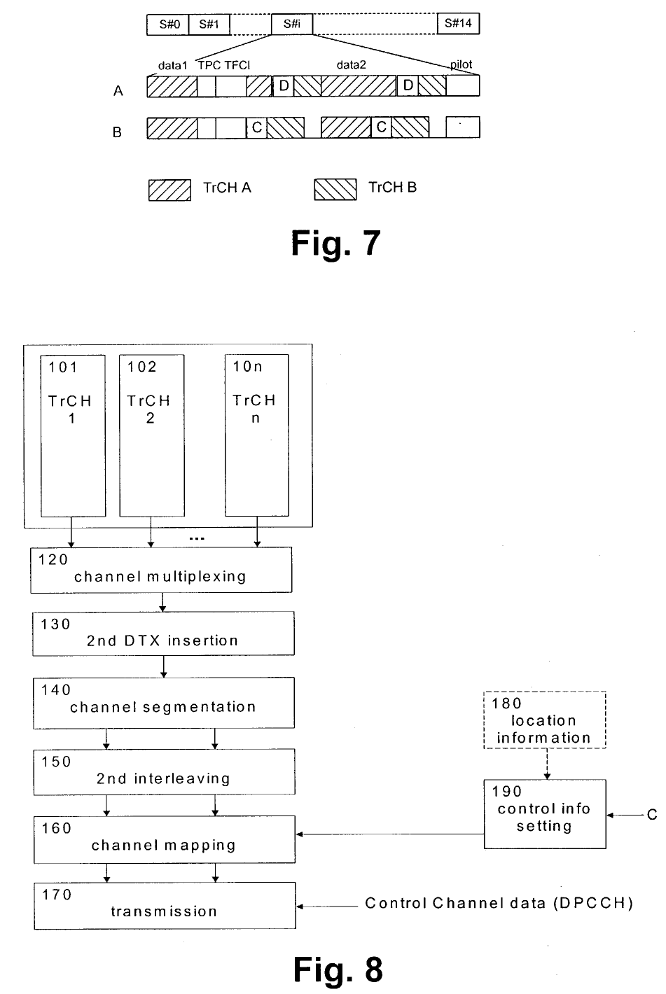

FIG. 7 shows a frame structure according to a fourth preferred embodiment, in which the dummy bits D are provided at flexible positions. The location of the flexible positions may be defined by selecting a pre-determined transport channel TrCH C whose position within the frame and each slot can then be derived on the basis of the TFCI given in each slot. In FIG. 7, the proposed upper slot structure A according to the fourth preferred embodiment comprises dummy bits D inserted in the selected dummy transport channel TrCH C which is multiplexed between TrCH A and TrCH B in this figure. At a Node B, the dummy bits D may then be replaced by the control bits C, as indicated in the lower slot structure B. Thus, one transport channel, e.g. the last one in the slot or the second one as in FIG. 7 is configured to send the dummy data or dummy bits D either in every frame are periodically.

Those Node Bs which use the advanced signaling methods, e.g. the HSDPA feature, replace the dummy bits D with the Node B specific control bits C while conventional Node Bs not compliant with the enhanced signaling just send the dummy bits D. Terminal devices such as the UE 10 will then ignore the data received from conventional Node Bs. An information indicating in which cell the proposed control signaling is used can be informed to the terminal devices, e.g. by an RRC signaling or via a broadcast channel.

When the dummy/control information is in flexible positions, in order to know the frame structure, the receiving entity has to read the TFCI information. However, this can only be done at the end of the frame when the whole TFCI word has been received. Irrespective of the definition of the signaling timing of the dummy transmission channel, e.g. always transmitted or periodically transmitted, the locations of the dummy bits depend on the TFCI, i.e. data rates etc. of the other transmission channels. Thus, the receiving entity does not know where the control bits are before it has decoded the TFCI. In case the dummy bits are transmitted within selected slots and not interleaved over the whole frame, the use of flexible positions is only possible with some restrictions. The transmitting entity has to know the positions so as to be able to insert the control bits C to the given slots after the second interleaving. Then, the receiving entity waits until the end of the radio frame F, and then decodes the TFCI to get knowledge of the bit positions. This could be beneficial in the sense that it gives more processing time for the transmitting entity, e.g., a Node B, which could process a transport block received in the uplink direction during e.g. 5 ms, i.e. half of the next frame length, and then insert the control signaling, e.g. an ACK/NACK message of the enhanced uplink signaling, in the second half of the frame length. Thereby, 10 ms could be saved as compared to the alternative operation where the signalings are sent in different transmission timing intervals (TTIs). It is thus beneficial to use the last slots of the frame F for the control bits C, as this maximizes the processing time in the transmitting entity. The receiving entity anyway would have to wait until the end of the frame F before being able to start decoding.

Thus, the advantage of the use of selected slots as compared to an interleaving over the whole frame is that a time period of at least 10 ms can be saved, i.e. the control signaling can be sent at the end of frame i instead of sending it in the whole frame i+1. Moreover, another 10 ms can be saved if the same principle is used in the uplink direction as well, e.g. for signaling a rate request (RR) from the UE 10 and a rate grant (RG) from one of the Node Bs 20, 22.

In general the proposed control signaling can be used in both uplink and downlink directions. In the uplink direction the dummy bits may be filled by the rate matching functionality. The enhanced Node Bs would then decode the control bits C, e.g. after decoding of the TFCI, while the conventional Node Bs would treat the control data C as a normal transmission channel, decode it and pass it to the respective RNC 30, 32, which then interprets the received data as dummy data.

In the uplink direction, no DTX is currently used and instead rate matching is used to fill the frame. This implies that in the uplink only flexible positions of the transport channels are supported. The number of channel bits transmitted for a given transport channel depends on the number of bits on the other transport channels as well as on the rate matching parameters. Thus if a fixed number of channel bits per frame for the dummy transport channel is required, the number of input bits and rate matching parameters have to be set for each TFC separately. Since the frame is always filled in the uplink, it is preferable to use either the first or the last transport channel, since the position of the first bits of the first transport channel as well as the position of the last bits of the last transport channel are known even without reading the TFCI. Thus it is possible to define fixed positions for the dummy bits in the uplink, too. However, due to the structure of the uplink, flexible positions of the dummy/control data are more suitable for the uplink. Then for time critical data, the last slots of the frame should preferably be used for control data since TFCI needs to be decoded before the position of the control is known. In the earlier slots, the dummy bits may be replaced with less time critical control information.

FIG. 8 shows a schematic diagram of a WCDMA transport channel multiplexing structure for the downlink direction, as provided in a transmitting entity, e.g. the Node Bs 20, 22. According to this multiplexing structure, channel signals obtained from individual channel processing stages 101, 102 to 10n of the channels TrCH1, TrCH2, . . . , TrCHn are multiplexed at a transport channel multiplexing function 120. The multiplex signal is then processed in a second insertion function 130 of a DTX indication and supplied to a physical channel segmentation function 140. The segmented physical channel signals are supplied to a second interleaving function 150 and a physical channel mapping function 160 before being processed for transmission in a transmission unit 170 together with control channel data supplied e.g. from a dedicated physical control channel (DPCCH). A control information setting unit 190 is provided to which the desired control bits C replacing the dummy bits D are supplied.

According to the first, second and third preferred embodiments, the control information setting unit 190 is arranged to replace the dummy bits D at the proposed fixed positions of the known transport channel.

In FIG. 8, the specific elements of the fourth preferred embodiment are indicated by dotted lines. According to the fourth preferred embodiment, a location information deriving unit 180 is provided which receives from higher protocol layers the TFCI information of the concerned frame/slots in order to derive a location information of the flexible positions of the dummy bits D within the concerned slots. Based on this location information, the control information setting unit 190 replaces the dummy data D by the supplied control data C. This may be achieved, e.g., in the physical channel mapping function 160 after the second interleaving function 150.

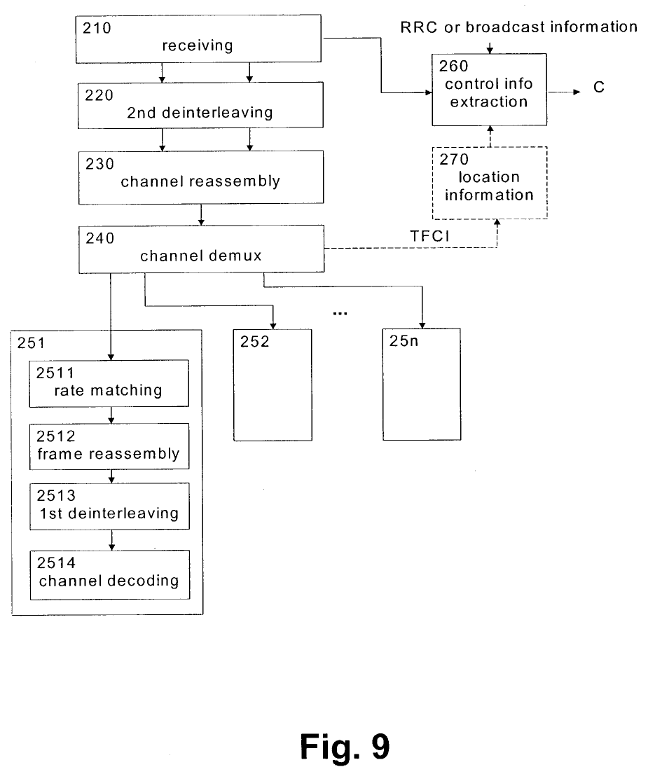

FIG. 9 shows a demultiplexing structure for demultiplexing the received time multiplex signal at a receiving entity to be controlled on the basis of the supplied control bits C, e.g. the UE 10. The demultiplexing structure comprises a receiving unit 210 for receiving physical channel signals I and Q of the time multiplex signal and supplying the physical channel signals to a second deinterleaving stage 220 for performing a deinterleaving function so as to remove the distribution caused by the second interleaving function of the multiplexing structure of FIG. 8. The deinterleaved physical channel signals are supplied to a physical channel reassembly function 230 in which a single physical channel signal is generated from the received physical channel signals and supplied to a transport channel demultiplexing function 240. There, demultiplexed individual transport channel signals are generated and supplied to individual transport channel processing units 251, 252, . . . 25n. At each transport channel processing unit, the demultiplexed transport channel signal is supplied successively to a rate matching function 251, frame reassembly function 2512, first deinterleaving function 2513 which removes the data distribution caused by a first interleaving function at the respective channel processing unit of the multiplexing structure of FIG. 8, and a channel decoding function 2514.

It should be noted that if the UE is in soft handover (SHO) with several Node Bs, which may transmit independent control information to the UE, the control information has to be extracted before the macro diversity combining of the received signals is performed. However, the combining of the multipath components received from the same Node B can be performed before extracting the control information. Both multipath combining as well as the macro diversity combining are typically done in the rake receiver, which in the case of this invention requires some changes as described above. The control information from different Node Bs is kept separate (only multipaths combined). However, the normal data bits can be combined as earlier.

According to the first, second and third preferred embodiments, the position of the control information is fixed and thus known before decoding of the TFCI. Then the control information can be extracted immediately. This is beneficial especially when the UE is in SHO since the control information can be extracted immediately from the signals received from different Node Bs before macro diversity combining and the rest of the bits can be macro diversity combined.

According to the fourth preferred embodiment, a location information deriving unit 270 is provided to which the TFCI information is supplied by the channel demultiplexing function 240. Based on this TFCI, the location information deriving unit 270 derives the location of the control bits C and supplies this location information to an extraction unit 260 which then extracts the control bits C from the respective transmission channel or transmission channel portion indicated by the location information. Based on a supplied RRC or broadcast signaling, the extraction unit 260 may be informed whether the current cell or Node B supports the proposed control signaling function. If not, the extraction unit 260 may be deactivated so as to ignore the information transmitted at the derived location. It should be noted that in the downlink direction the use of flexible positions is less advantageous, especially in SHO, since all the bits from the slots where the control information is transmitted from all the Node Bs, need to be separately buffered in order to be able to extract the control information later when the positions of the control bits are known based on the decoded TFCI. In the uplink direction, however, no macro diversity combining is performed in the Node B and normal rake combining can be performed. The control information can be even extracted after the deinterleaving, e.g., in the channel demultiplexing function where the different transport channels are normally separated. Thus extra buffering in the Node B receiver can be avoided. Therefore, the use of the flexible positions of the dummy/control information is more suited for the uplink transmission.

Accordingly, a space for signaling a control information is generated by creating dummy bits or a dummy transmission channel and using these dummy bits for control signaling purposes.

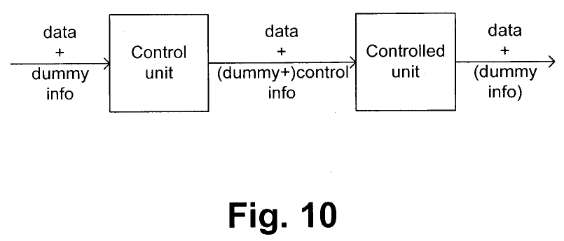

FIG. 10 shows a general schematic block diagram of the system. The control unit may be, e.g., the MAC or physical layer of the Node B or the UE, the controlled unit can be, e.g., UE or the Node B, respectively. The controlled unit could typically be the MAC or physical layer of the UE or Node B. The control unit receives some data and some dummy information or bits. In case, that the Node B is the control unit, it typically receives the data and dummy information from RNC, but especially when the control unit is the MAC or physical layer of the Node B, the data and dummy information can also come from the higher protocol layers of the Node B. In case, the UE, and especially the MAC or physical layer of the UE, is the control unit, the data and dummy information is typically received from the higher protocol layers of the UE. The control unit replaces at least part of the dummy information with the control information that it wants to send to the controlled unit and transmits the data and the control information to the controlled unit. If not all dummy information is replaced with control information, then also some dummy information may be transmitted but preferably the remaining dummy information is not transmitted, i.e., it is ‘DTXed’. The controlled device receives the data and the control information as well as possible dummy information. The controlled unit interprets the control information and acts accordingly. For instance, if the control information is a negative acknowledgement for a Hybrid ARQ (HARQ) process, the HARQ process retransmits the block. Or if the control information is a rate increase grant, allowing the controlled unit to increase its transmission data rate, then the controlled unit can increase its data rate when transmitting next time. The controlled unit also forwards the data it received, e.g., to the higher protocol layers. Depending on the configuration, the controlled unit may also forward the control information and possible dummy information, both of which are typically dummy information for other units.

It is noted that the present invention is not restricted to the above preferred embodiments but can be used in any transmission signal so as to replace a dummy information by a desired control information at an intermediate network node provided on a transmission path to a controlled receiving entity. The dummy bits D may be replaced by any type of control signaling or control bits C to be exchanged. The preferred embodiments may thus vary within the scope of the attached claims.

1. A method of forwarding a control information in a transmission signal to a controlled unit, said method comprising the steps of:
(a) providing dummy information in at least one predetermined portion of said transmission signal;
(b) replacing at least part of said dummy information by said control information at a control device arranged on the transmission path of said transmission signal; and
(c) transmitting the transmission signal with said added control information to said controlled unit.

2. A method according to claim 1, wherein said transmission signal is a multiplex signal having a frame and slot structure.

3. A method according to claim 1 or 2, wherein said dummy information is provided at a fixed position within said transmission signal.

4. A method according to claim 3, wherein said dummy information is provided at a fixed position within at least a slot of said multiplex signal.

5. A method according to claim 3 or 4, wherein said dummy information is a DTX information.

6. A method according to claim 1 or 2, wherein said dummy information is provided at a flexible position within said transmission signal.

7. A method according to claim 6, wherein said dummy information is provided at a flexible position within at least a slot of said multiplex signal.

8. A method according to claim 5, wherein said dummy information is provided at the end of a first and second half of a data field of at least one slot.

9. A method according to any one of claims 3 to 5, wherein said dummy information is provided in a dummy transport channel arranged at a fixed frame position.

10. A method according to any one of claims 4 or 5, wherein said dummy information is provided in a dummy transport channel arranged at a flexible frame position, said dummy transport channel corresponding to at least one of the first and last transport channels within the frame.

11. A method according to claim 7, wherein said dummy information is provided in a dummy transport channel arranged at a flexible frame position.

12. A method according to any one of claims 1 to 11, wherein said dummy information is provided in a dedicated channel.

13. A method according to any one of claims 1 to 11, wherein said dummy information is provided in a common or shared channel.

14. A method according to any one of claims 7 and 13, wherein said flexible positions are determined at said controlled unit based on a format indication information.

15. A method according to claim 14, wherein said format indication information is a TFCI of said time slot.

16. A method according to claim 14 or 15, wherein said flexible positions are determined by decoding said format indication information.

17. A method according to claim 7, wherein a control procedure corresponding said control information is activated during the last time slots of a frame.

18. A method according to claim 7, wherein said dummy information is replaced with said control information in the last time slots of a frame.

19. A method according to any one of claims 2 to 18, wherein said dummy information is transmitted periodically.

20. A method according to claim 19, wherein said dummy information is transmitted in every frame of said time multiplex signal.

21. A method according to any one of the preceding claims, wherein non-replaced dummy information is replaced at said control device by a DTX information.

22. A method according to any one of the preceding claims, wherein said control information is interleaved over a whole frame of said transmission signal.

23. A method according to claim 22, wherein said replacing step is performed at said control device before channel coding and multiplexing.

24. A method according to claim 2, wherein said control information is transmitted in selected time slots of said multiplex signal.

25. A method according to claim 24, wherein said replacing step is performed after a final interleaving operation, when the final positions of said dummy information within said selected time slots are known.

26. A method according to claim 22, wherein said final interleaving operation is a second interleaving operation.

27. A method according to any one of claims 24 to 26, wherein said control information is extracted at said controlled unit before a second deinterleaving operation.

28. A method according to any one of the preceding claims, wherein said transmission signal is an uplink or downlink signal of a cellular network.

29. A method according to claim 28, wherein said control information comprises HSDPA signaling information.

30. A system for forwarding a control information in a transmission signal to a controlled unit (10), said system comprising:
(a) signal generating means for providing said transmission signal with dummy information in at least one predetermined portion of said transmission signal; and
(b) a control unit arranged on the transmission path of said transmission signal and adapted to replace at least part of said dummy information by said control information and to transmit said transmission signal with said added control information to said controlled unit.

31. A system according to claim 30, wherein said control unit is a base station device (20, 22) and said controlled unit is a terminal device (10).

32. A system according to claim 31, wherein said control information is extracted before macro diversity combining in said terminal device (10).

33. A system according to claim 30, wherein said control unit is terminal device (10) and said controlled unit is a base station device (20, 22).

34. A system according to claim 33, wherein said control information is replaced at a flexible position within a time slot of said transmission signal, and said control information is extracted at said controlled unit (20, 22) after transport channel demultiplexing.

35. A system according to any one of claims 30 to 34, wherein said signal generating means is arranged to provide said dummy information at fixed or flexible positions within a time slot of said transmission signal, said transmission signal being a time multiplex signal.

36. A system according to claim 35, wherein said control unit (20, 22) is arranged to derived said flexible positions from a transport format indication information of said time slot.

37. A control device of a cellular network, said device comprising:
(a) receiving means (200) for receiving a transmission signal;
(b) replacing means (190) for replacing at least part of dummy information provided in at least one predetermined portion of said transmission signal by a control information; and
(c) transmitting means (170) for transmitting said transmission signal with said added control information to a controlled device to be controlled based on said control information.

38. A device according to claim 37, wherein said control device is a base station device (20, 22) or a terminal device (10).

39. A device according to claim 37 or 38, wherein said replacing means (190) is arranged to replace said dummy information at flexible positions before a channel coding and rate matching of said transmission signal, the transmission signal being a multiplex signal.

40. A device according to claim 37 or 38, wherein said replacing means (190) is arranged to replace said dummy information at fixed positions after a final interleaving processing before transmission of the transmission signal.

41. A device according to claim 39, wherein deriving means (180) are provided for deriving a location information of said flexible position from a transport format indication information of said time slot.

42. A device to be controlled by a control information received in a transmission signal, said controlled device comprising:
(b) deriving means (270) for deriving from said received transmission signal a location information of a channel used for transmitting said control information; and
(c) extracting means (260) for extracting said control information based on said derived location information.

43. A device according to claim 42, wherein said deriving means (270) are adapted to derive said location information from a transport format indication information of the time slots of said transmission signal, said transmission signal being a multiplex signal.

44. A device according to claim 42 or 43, wherein said extracting means (260) are adapted to receive an indication information from said cellular network, indicating the presence of said control information.

45. A device according to claim 44, wherein said indication information is supplied from a cellular network by an RRC or broadcast signaling.

46. A device according to any one of claims 42 to 45, wherein said controlled device is a base station device (20, 22) or a terminal device (10).
